(19) United States
(12) Patent Application Publication
(10) Pub. No.: US 2013/0070905 A1
(43) Pub. Date: Mar. 21, 2013

(54) X-RAY WAVEGUIDE AND METHOD OF PRODUCING THE WAVEGUIDE

(71) Applicants: Atsushi Komoto, Moriya-shi (JP); Hirokatsu Miyata, Hadano-shi (JP); Wataru Kubo, Inagi-shi (JP); Kohei Okamoto, Yokohama-shi (JP); Takashi Noma, Hadano-shi (JP)

(72) Inventors: Atsushi Komoto, Moriya-shi (JP); Hirokatsu Miyata, Hadano-shi (JP); Wataru Kubo, Inagi-shi (JP); Kohei Okamoto, Yokohama-shi (JP); Takashi Noma, Hadano-shi (JP)

(73) Assignee: CANON KABUSHIKI KAISHA, Tokyo (JP)

(21) Appl. No.: 13/700,612

(22) PCT Filed: May 20, 2011
(86) PCT No.: PCT/JP2011/062153

§ 371 Date: Nov. 28, 2012

(30) Foreign Application Priority Data
Jun. 2, 2010 (JP) 2010-127336

(51) Int. Cl. G21K 1/00

(52) U.S. Cl. 378/145; 29/592

(57) ABSTRACT

An X-ray waveguide according to the present invention includes: a core for guiding an X-ray; and a cladding for confining the X-ray in the core, wherein: the core has a low electron density portion and a high electron density portion having a higher electron density than an electron density of the low electron density portion; the low electron density portion is provided in the high electron density portion; and the low electron density portion is formed of one of a pore and an organic substance.

### TECHNICAL FIELD

The present invention relates to an X-ray waveguide formed of a core and a cladding, in particular, an X-ray waveguide whose core is such that a low electron density portion is provided in a high electron density portion.

### BACKGROUND ART

As in the case of a conventional optical waveguide used in a visible light region or the like, a waveguide for an X-ray is of a configuration formed of a core and a cladding which surrounds the periphery of the core and has a smaller refractive index than that of the core, and is mainly used for obtaining an X-ray having a small beam size and a strong intensity. In the case of the waveguide for an X-ray, the X-ray is made incident on the waveguide at a small angle as compared with that of, for example, the waveguide for the visible light region because of the following reason. The refractive index of a substance for the X-ray is close to 1, and hence a difference in refractive index between the core and the cladding cannot be made very large. In addition, an allowance range for the incidence angle of the X-ray for forming a guided mode (coupling) to propagate an X-ray is narrow, and hence it has been necessary to perform precise axis adjustment by reducing the divergence angle of the incident X-ray.

F. Peiffer et al., Phys. Rev. B62, p. 16939 to 16943 discloses an X-ray waveguide using an artificial multilayer film as a core. Used in F. Peiffer et al., Phys. Rev. B62, p. 16939 to 16943 described above is an artificial multilayer film having unit structures obtained by alternately forming, on a substrate, a member formed of carbon having a low electron density (low electron density portion) and a member formed of nickel having a high electron density (high electron density portion) by magnetron sputtering. The X-ray waveguide has a lager allowance range for the incidence angle of an X-ray than that of an X-ray waveguide whose core is uniformly formed because X-rays localized in the laminated low electron density portions of the artificial multilayer film interact with each other. The allowance range for the incidence angle is large, and hence even X-rays that have diverged to some degree can be efficiently coupled. Accordingly, a transmitted X-ray having an additionally strong intensity can be obtained.

However, F. Peiffer et al., Phys. Rev. B62, p. 16939 to 16943 involves a problem to be solved. That is, in a guided mode, an X-ray propagates in the waveguide while most of the intensity of the X-ray converges on the low electron density portion. As the electron density of a material increases, the linear absorption coefficient of the material for an X-ray generally increases, though whether or not the coefficient increase depends on the atomic composition of the material. However, the transmitting performance of the artificial multilayer film disclosed in F. Peiffer et al., Phys. Rev. B62, p. 16939 to 16943 for an X-ray cannot help being limitative because carbon is used in the low electron density portion and hence the electron density of the portion is still high. In view of the foregoing, an X-ray waveguide using a material having a lower electron density than that of carbon in a low electron density portion has been requested.

### SUMMARY OF INVENTION

The present invention has been made in view of such background art, and provides an X-ray waveguide having a high transmittance for an X-ray and a method of producing the waveguide by providing a core with a low electron density portion having a low electron density.

An aspect of the present invention is an X-ray waveguide including: a core for guiding an X-ray; and a cladding for confining the X-ray in the core, wherein: the core has a low electron density portion and a high electron density portion having a higher electron density than an electron density of the low electron density portion; the low electron density portion is provided in the high electron density portion; and the low electron density portion is formed of one of a pore and an organic substance. Further aspects of the present invention will become apparent from the following description of embodiments.

According to the present invention, there can be provided an X-ray waveguide having a high transmittance for an X-ray and a method of producing the waveguide by forming a low electron density portion used in a core from a pore or an organic substance.

Further features of the present invention will become apparent from the following description of exemplary embodiments with reference to the attached drawings.

### BRIEF DESCRIPTION OF DRAWINGS

FIG. 1A is a schematic view illustrating an embodiment of an X-ray waveguide of the present invention.

FIG. 1B is a schematic view illustrating an embodiment of the X-ray waveguide of the present invention.

FIG. 2A is a schematic view illustrating an example of the configuration of the X-ray waveguide.

FIG. 2B is a schematic view illustrating an example of the configuration of the X-ray waveguide.

FIG. 3A is a schematic view illustrating an example of the configuration of the X-ray waveguide and a method of making an X-ray incident.

FIG. 3B is a schematic view illustrating an example of the configuration of the X-ray waveguide and the method of making an X-ray incident.

FIG. 4A is a step view illustrating an embodiment of a method of producing an X-ray waveguide of the present invention.

FIG. 4B is a step view illustrating an embodiment of the method of producing an X-ray waveguide of the present invention.

FIG. 4C is a step view illustrating an embodiment of the method of producing an X-ray waveguide of the present invention.

FIG. 4D is a step view illustrating an embodiment of the method of producing an X-ray waveguide of the present invention.

FIG. 4E is a step view illustrating an embodiment of the method of producing an X-ray waveguide of the present invention.

FIG. 5A is a schematic view for illustrating Example 1, Example 2, and Comparative Example 1 of the present invention.

FIG. 5B is a schematic view for illustrating Example 1, Example 2, and Comparative Example 1 of the present invention.

FIG. 5C is a schematic view illustrating the configuration of a core of Example 1 of the present invention.

FIG. 5D is a schematic view illustrating the configuration of a core of Example 2 of the present invention.

FIG. 6 is a view illustrating the incidence angle dependence of a transmitted x-ray intensity in each of Example 1 and Example 2.

### DESCRIPTION OF EMBODIMENTS

Preferred embodiments of the present invention will now be described in detail in accordance with the accompanying drawings.

An X-ray waveguide according to the present invention is an X-ray waveguide formed of a core and a cladding, and is characterized in that: the core is such that a low electron density portion having a low electron density is provided in a high electron density portion having a high electron density; and the low electron density portion is formed of a pore or an organic substance.

In particular, the waveguide is characterized in that: the core is formed of a laminating structure obtained by laminating unit structures in each of which the low electron density portion is provided in the high electron density portion in a certain direction; and the laminating direction of the unit structures of the laminating structure is a direction perpendicular to the propagating direction of an X-ray. Note that, the term “X-ray” as used in the present invention refers to electromagnetic waves in such a wavelength band that the refractive index real part of a substance is 1 or less. Specifically, the term “X-ray” as used in the present invention refers to electromagnetic waves each having a wavelength of 100 nm or less including extreme ultraviolet light (EUV light).

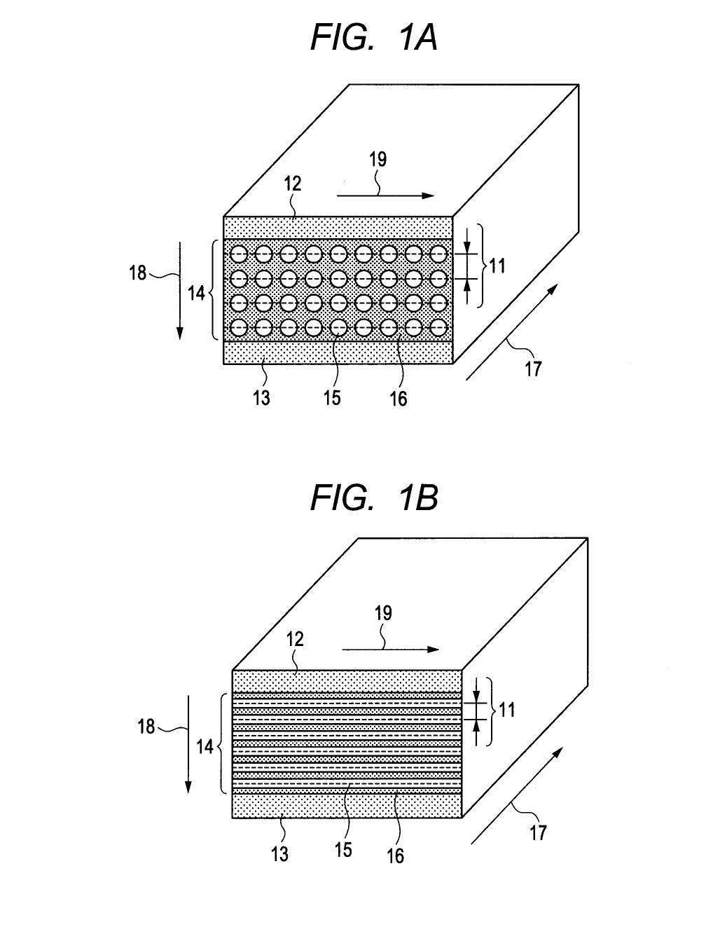

FIGS. 1A and 1B are each a schematic view illustrating an embodiment of the X-ray waveguide of the present invention. In FIGS. 1A and 1B, the X-ray waveguide of the present invention is formed of a configuration formed of a core 14, and claddings 12 and 13 in which the core 14 is such that a low electron density portion 15 is provided in a high electron density portion 16. An X-ray waveguide that provides a stronger transmitted X-ray than that of a conventional waveguide can be provided because the low electron density portion 15 in which an X-ray is localized is a pore or an organic substance.

In addition, the core 14 is a laminating structure obtained by laminating unit structures 11 in each of which the low electron density portion 15 is provided in the high electron density portion 16 in a certain direction. As a result, the localization of an X-ray into the low electron density portion becomes significant, and hence an X-ray waveguide that provides an additionally strong transmitted X-ray can be provided.

The core 14 formed of a laminating structure is formed by laminating the unit structures 11. The unit structures 11 are each formed of the tubular or spherical low electron density portion 15 formed of a member having a low electron density that propagates an X-ray and the high electron density portion 16 formed of a member having a high electron density, and the low electron density portion is provided in the high electron density portion in the certain direction. A direction 19 is the certain direction in which the low electron density portion is provided. In addition, a laminating direction 18 of the unit structures 11 is a direction perpendicular to a propagating direction 17 of the X-ray.

Examples of the core 14 formed of the laminating structure of the present invention include films mainly formed of two structures. FIG. 1A illustrates a film in which the low electron density portions 15 are tubular or spherical unit structures provided in a certain direction and the portions are laminated in the high electron density portion 16 (hereinafter referred to as a “non-laminar structure”). In addition, FIG. 1B illustrates a film in which the low electron density portions 15 and the high electron density portions 16 form a laminar structure and the portions are alternately laminated (hereinafter referred to as a “laminar structure”).

The unit structures 11 are characterized in that their electron densities averaged with respect to a plane perpendicular to the laminating direction 18 repeatedly have a high density region and a low density region along the laminating direction 18. A size (laminating interval) in a direction parallel to the laminating direction 18 of the unit structures is not necessarily needed to be constant.

It is preferred that: the certain direction 19 in which the low electron density portions 15 of the unit structures 11 are provided be a direction parallel to the cladding 13; and the laminating direction 18 of the unit structures 11 be a direction perpendicular to the cladding 13. With the configuration, an X-ray can be preferably confined in the waveguide, and the X-ray can be localized in each low electron density portion. Accordingly, an X-ray waveguide that provides a strong transmitted X-ray can be provided.

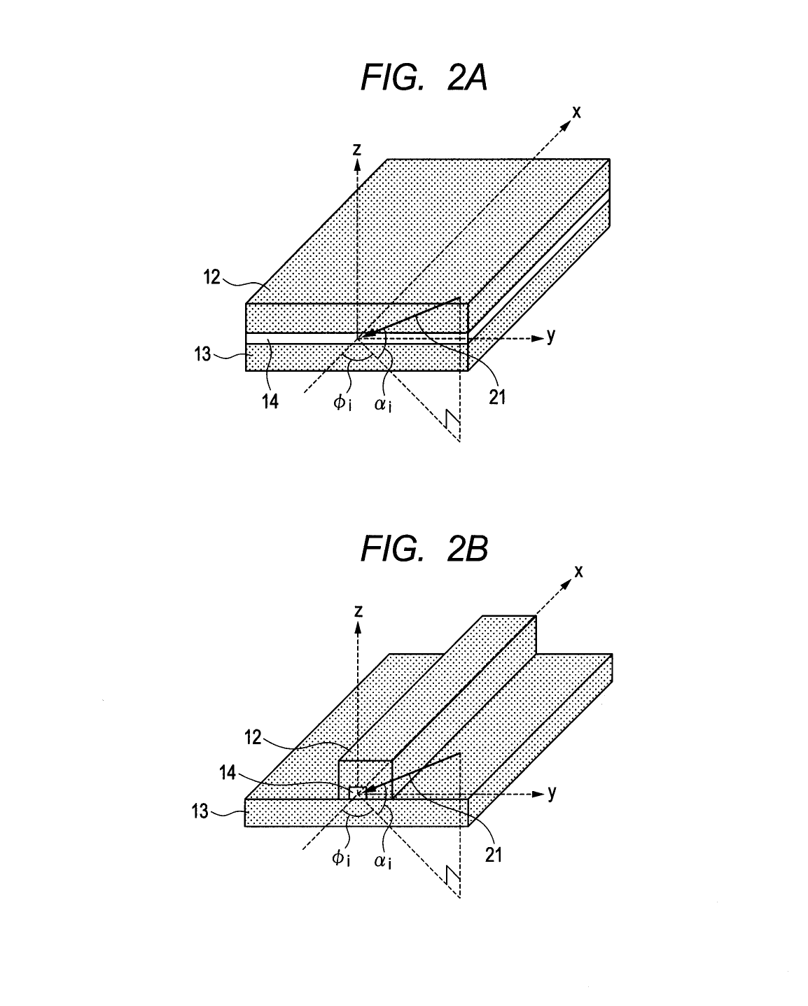

In the present invention, as illustrated in FIGS. 2A and 2B, the claddings 12 and 13 are formed on the periphery, or on the upper and lower portions, of the core 14 formed on a substrate as the cladding 13. In FIGS. 2A and 2B, the position at which an X-ray 21 is incident on the X-ray waveguide is the origin of coordinates, and the propagating direction of the X-ray is defined as an x-axis. In addition, an incidence angle in the in-plane direction of the X-ray waveguide out of the incidence angle of the X-ray on the X-ray waveguide is represented by φᵢ, and an incidence angle in the out-of-plane direction of the X-ray waveguide out of the incidence angle of the X-ray on the X-ray waveguide is represented by φᵢ (hereinafter, the incidence angle of an X-ray is defined by these variables illustrated in FIGS. 2A and 2B).

Two kinds of X-ray waveguides are available. The two kinds are such a one-dimensional confinement-type waveguide as illustrated in FIG. 2A of a plate structure in which the core 14 is interposed between the claddings 12 and 13, and such a two-dimensional confinement-type waveguide as illustrated in FIG. 2B in which the periphery of the line-shaped core 14 on the cladding 13 is surrounded with the cladding 12. In the case of the one-dimensional confinement-type waveguide, proper setting of the wavelength and incidence angle (αᵢ) of an X-ray in accordance with the shape of the waveguide results in the formation of a guided mode in the waveguide, and hence an X-ray confined in a z direction propagates in the x-axis direction. In the case of the two-dimensional confinement-type waveguide, an X-ray can be confined even in a y-axis direction and then propagated by properly setting the φᵢ as well as the characteristics of the one-dimensional confinement-type waveguide. In the two-dimensional confinement-type waveguide, an X-ray is two-dimensionally confined in the waveguide. Accordingly, an X-ray beam having additionally suppressed divergence property and a small beam size can be extracted.

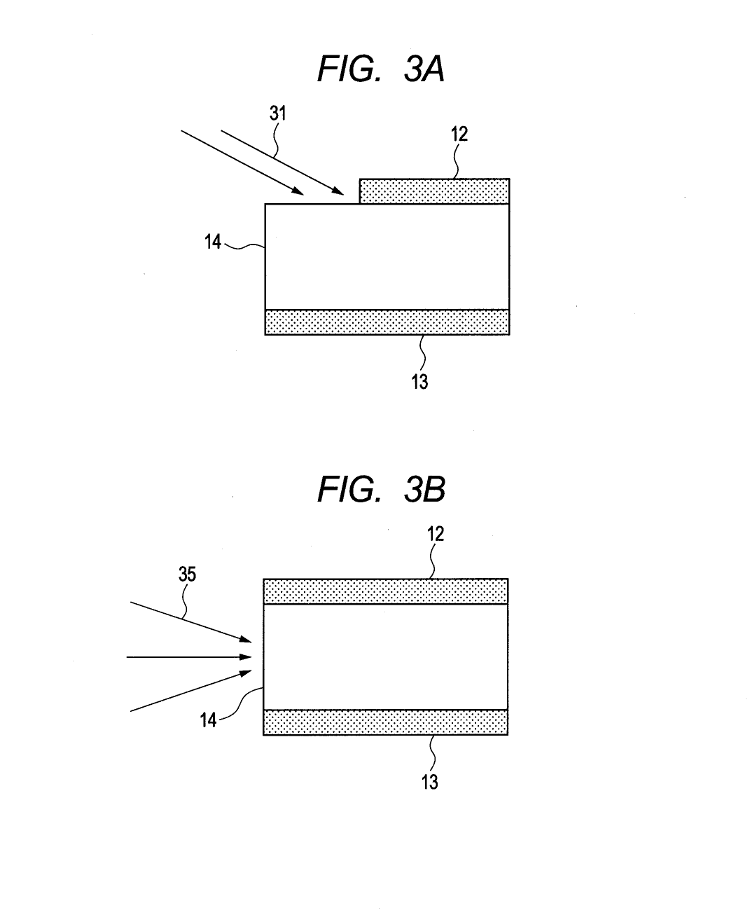

With regard to the shape of the portion of the X-ray waveguide on which an X-ray is incident and a method of making the X-ray incident, any method may be adopted as long as the X-ray can be guided into the X-ray waveguide by the method. For example, configurations illustrated in FIGS. 3A and 3B are given. In FIGS. 3A and 3B, the X-ray waveguide is formed of the claddings 12 and 13, and the core 14. In FIG. 3A, X-rays 31 having a high collimation (each having a small divergence angle) are obliquely incident, and then the X-rays are propagated by forming a small number of guided modes in the waveguide. The waveguide is characterized in that the phases of transmitted X-ray beams to be obtained are relatively matched because the number of the guided modes is small. On the other hand, in FIG. 3B, condensed X-rays 35 are incident from an end face of the X-ray waveguide. With the configuration, a large number of guided modes can be formed in the waveguide, and hence an X-ray beam having a relatively strong intensity can be obtained.

In the present invention, it is preferred that: the core be formed of an inorganic oxide-organic substance laminar structure; and the core be formed of a configuration obtained by laminating unit structures in each of which a laminar low electron density portion formed of the organic substance is provided in a high electron density portion formed of the inorganic oxide in a certain direction. The use of the laminar low electron density portions each formed of the organic substance in the core can provide an X-ray waveguide excellent in optical characteristics such as an incidence allowance angle on the X-ray waveguide and a high X-ray transmittance.

It is also preferred that: the core be formed of an inorganic oxide porous body; and the core be formed of a configuration obtained by laminating unit structures in each of which a tubular or spherical low electron density portion formed of a pore or an organic substance in the pore is provided in a high electron density portion formed of the inorganic oxide in a certain direction. The use of the tubular or spherical low electron density portions each formed of the pore or the organic substance in the core can provide an X-ray waveguide excellent in optical characteristics such as an X-ray transmittance.

The sectional shapes of the tubular low electron density portions are, for example, a circular shape, an elliptical shape, a quadrangular shape, and a polygonal shape. The core having the tubular low electron density portions is, for example, a porous silica, a porous titanium oxide, or a porous alumina. The core having the spherical low electron density portions is, for example, a hexagonal close-packed structure (reverse opal structure) formed of polystyrene spheres in the matrix of the high electron density portions in a self-assemble fashion or a mesoporous silica. Although the spherical structures are not needed to be completely spherical, an aspect ratio (shorter diameter of a pore section/longer diameter of the pore section) is preferably 0.30 or more.

As described above, in the present invention, the low electron density portions 15 are each formed of the pore or the organic substance. In the case of the core of FIG. 1A (non-laminar structure), the unit structures formed of the low electron density portions 15 are each formed of the pore or the organic substance. On the other hand, in the case of the core of FIG. 1B (laminar structure), the low electron density portions 15 are each formed of the organic substance. The electron density of each of the low electron density portions 15 is smaller than that of a conventional X-ray waveguide using an artificial multilayer film in its core because the low electron density portions 15 are each the pore or the organic substance. As a result, the absorption of an X-ray can be suppressed, and hence a transmitted X-ray having a strong intensity can be extracted. In particular, a transmitted x-ray intensity can be significantly increased as compared with a conventional one by turning the low electron density portions 15 into pores.

Examples of the organic substance include, for example, an amphipathic molecule typified by a surfactant or polymer, an alkyl chain moiety of a siloxane oligomer, an alkyl chain moiety of a silane coupling agent, and polymer particles. Examples of the surfactant include C₁₂H₂₅(OCH₂CH₂)₄OH, C₁₆H₃₅(OCH₂CH₂)₁₀OH, C₁₈H₃₇(OCH₂CH₂)₁₀OH, a Tween 60 (Tokyo Chemical Industry Co., Ltd.), a Pluronic L121 (BASF), a Pluronic P123 (BASF), a Pluronic P65 (BASF), and a Pluronic P85 (BASF).

Table 1 shows an exemplary linear absorption coefficient as an index for the transmitting performance of a material used in each low electron density portion for an X-ray (12 keV). As can be seen from the table, the linear absorption coefficients of a pore and organic substances are smaller than that of carbon, and hence the pore and the organic substances each have higher transmitting performance than a conventional one.

TABLE 1

| Material for low electron density | Linear absorption |
|---|---|
| portion | coefficient (m⁻¹) |
| C₁₆H₃₅(OCH₂CH₂)₁₀OH (surfactant) | 147.6 |
| Alkyl | 110.7 |
| Pore (air) | 0.363 |
| Carbon | 249.0 |

It should be noted that the term “alkyl” refers to a portion (functional group) of a molecule formed of CₙH₂ₙ₊₁. In the present invention, a material for the high electron density portion 16 has only to have a larger electron density than that of the low electron density portion 15, provided that as the abruptness of the change of a difference in electron density between the high electron density portion 16 and the low electron density portion 15 raises, the localization of X-rays into the low electron density portions 15 becomes more significant, and hence an X-ray waveguide that provides a strong transmitted X-ray can be provided. In addition, the high electron density portion is particularly preferably an inorganic oxide when a material having high unit structure property is produced by a self-assembly process to be described later. Examples of the inorganic oxide include silica, titanium oxide, and zirconium oxide.

In the X-ray waveguide of the present invention, the thickness of the high electron density portion 16 of the core 14 is preferably twice or less as large as the length by which the evanescent wave of an X-ray oozes toward the high electron density portion. An oozing length L of the evanescent wave of an X-ray to be used toward the high electron density portion 16 is represented by (Formula 1) described below. Under the condition, X-rays localized in the low electron density portions can preferably interact with each other, and hence a degenerated guided mode is formed. As a result, an X-ray waveguide having a large allowance range for the incidence angle of an X-ray can be provided.

$$\begin{matrix}[ Formula 1 ] & \\ L = \frac{λ}{2 π \sqrt{{n}_{1}^{2} {cos}^{2} α - {n}_{2}^{2}}} & ( 1 )\end{matrix}$$

L: The oozing length of an evanescent wave
λ: The wavelength of an X-ray
n₁: The refractive index of the low electron density portion
n₂: The refractive index of the high electron density portion
α: The incidence angle of the X-ray from the low electron density portion to the high electron density portion

In the present invention, the thickness of each of the claddings 12 and 13 is preferably equal to or larger than the oozing length L of the evanescent wave of an X-ray toward the cladding. When the thickness of each of the claddings is equal to or larger than the L, the X-ray is satisfactorily confined in the X-ray waveguide, and hence the loss of the intensity of the X-ray can be suppressed.

A method of producing an X-ray waveguide of the present invention is a method of producing an X-ray waveguide formed of a core and a cladding in which: the core is such that a low electron density portion having a low electron density that propagates an X-ray is provided in a high electron density portion having a high electron density; and the low electron density portion is formed of a pore or an organic substance, the method being characterized by including the steps of: preparing a substrate serving as a part of the cladding; forming the core on the surface of the substrate; and forming another part of the cladding on a part, or on the periphery, of the core.

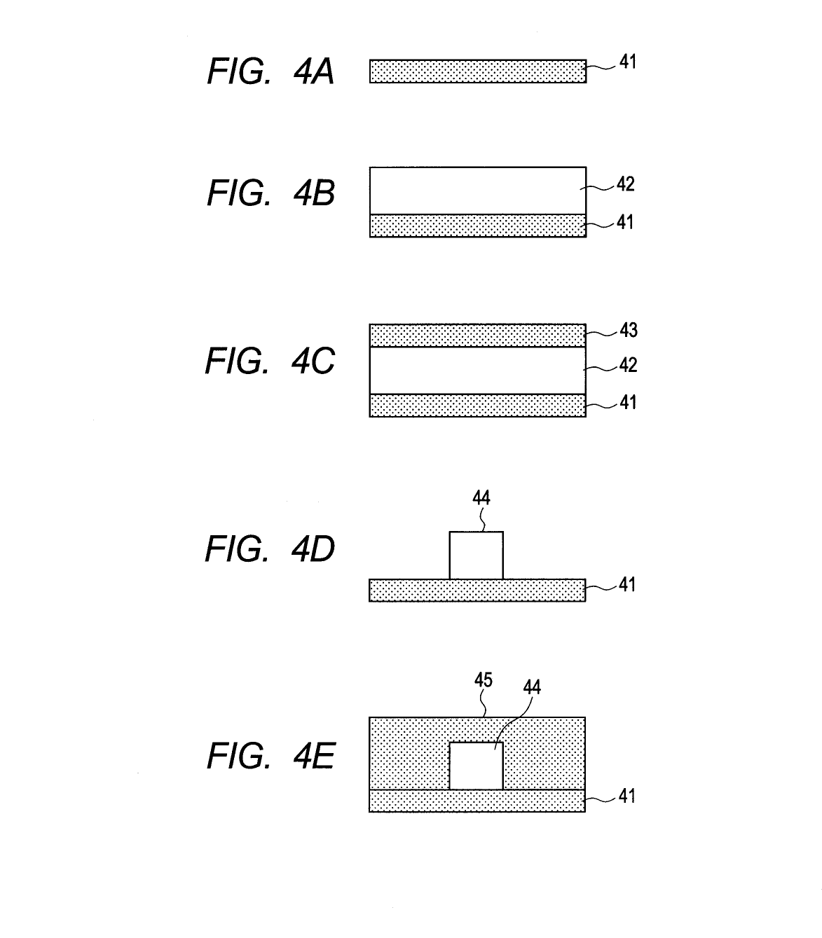

The step of forming the core is preferably performed by a self-assembly process involving using a reaction liquid containing an organic substance. FIGS. 4A, 4B, 4C, 4D, and 4E are each a step view illustrating an embodiment of the method of producing an X-ray waveguide of the present invention. When the X-ray waveguide of the present invention is a one-dimensional confinement-type waveguide, the waveguide is produced by the step of FIG. 4A, the step of FIG. 4B, and the step of FIG. 4C. In the step of FIG. 4A, a substrate 41 serving as a part of the cladding is prepared. In the step of FIG. 4B, a core 42 in which a low electron density portion is provided in a high electron density portion is formed on the surface of the substrate 41. In the step of FIG. 4C, a cladding 43 serving as the other part is formed on the core 42.

In addition, when the X-ray waveguide of the present invention is a two-dimensional confinement-type waveguide, the waveguide is produced by the step of FIG. 4A, the step of FIG. 4D, and the step of FIG. 4E. In the step of FIG. 4A, the substrate 41 serving as a part of the cladding is prepared. In the step of FIG. 4D, a line-shaped core 44 is formed on the surface of the substrate 41. In the step of FIG. 4E, a cladding 45 serving as the other part is formed on the periphery of the core 44.

The core of the X-ray waveguide of the present invention is preferably formed on a material for the cladding because the core is interposed between the claddings each, or surrounded with the cladding, having a smaller refractive index than that of the core. In the present invention, the surface portion of the substrate is preferably formed of the material for the cladding. When the substrate itself insufficiently functions as the cladding, the surface of the substrate needs to be treated. A method of treating the substrate is, for example, an oxidation treatment (formation of an oxide film) or film formation by sputtering or the like. Any such method can cause the surface layer of the substrate to function as the cladding. In addition, the treatment step may be performed before the step of forming the core on the substrate, or may be performed after the forming step.

A material having a smaller refractive index than that of the core, that is, having a larger electron density than that of the core is used as a material of which the cladding is formed, and examples of the material include an inorganic oxide and a heavy metal element. In the present invention, the core, which is not particularly limited, is preferably a core produced by a method based on a self-assembly process involving using a reaction liquid containing an organic substance. The core can be produced by employing a conventionally known method. For example, the core can be produced by employing a method (hydrothermal synthesis method) involving treating the surface of the substrate as the cladding through a chemical reaction caused by bringing a reaction liquid containing a surfactant, a precursor for a high electron density member, and an acid into contact with the surface and by holding the reaction liquid on the surface. Alternatively, the core can be produced by employing, for example, a method (sol-gel method) of forming the core upon evaporation of the solvent of the reaction liquid applied to the surface of the substrate by a method such as spin coating, dip coating, or capillary coating. Alternatively, the core can be produced by a sol-gel method involving applying, to the surface of the substrate, a reaction liquid containing an alkyl chain-containing siloxane oligomer or silane coupling agent. In any such method, a structure in which a large number of low electron density portions are provided in a high electron density portion can be produced at a time on the basis of self-assembly according to a wet process. Therefore, an X-ray waveguide can be produced with ease and at a low cost as compared with a method according to a dry process such as sputtering that has been conventionally employed.

The low electron density portions of the core produced here are each preferably an organic substance. Such non-laminar structure as illustrated in FIG. 1A or such laminar structure as illustrated in FIG. 1B is formed depending on reaction conditions such as the kind of an organic component, the concentration of the organic component, and the temperature of the reaction liquid. For example, in the case where an application treatment is performed with a reaction liquid containing an alkyl chain-containing siloxane oligomer, the laminar structure is formed when the chain length of the alkyl chain is 16 in terms of a carbon number, or the non-laminar structure is formed when the chain length is 10 in terms of a carbon number. In addition, Table 2 shows an example of the structure of the core for an organic substance to be used in the case of the hydrothermal synthesis method.

TABLE 2

| Organic substance | Shape of core |
|---|---|
| C₁₂H₂₅(OCH₂CH₂)₄OH | Laminar structure |
| C₁₆H₃₅(OCH₂CH₂)₁₀OH | Non-laminar structure |
| C₁₈H₃₇(OCH₂CH₂)₁₀OH | Non-laminar structure |
| Tween 60 | Laminar structure |
| Pluronic L121 | Laminar structure |
| Pluronic P123 | Non-laminar structure |
| Pluronic P65 | Non-laminar structure |
| Pluronic P85 | Non-laminar structure |

In the case of the configuration using the non-laminar structure (FIG. 1A), the organic substance can be removed while the structure of the core is maintained. As a result, the low electron density portions can be turned into pores. Turning the low electron density portions into pores additionally reduces their electron densities, and hence an X-ray waveguide having additionally good transmitting performance for an X-ray is obtained.

Any one of the conventionally known methods can be employed for the removal of the organic substance. For example, baking in an oxygen atmosphere, extraction with a solvent, or ozone oxidation can be employed. Although the baking step is generally employed, the extraction with a solvent or the ozone oxidation is preferably employed when the core, the substrate, the cladding formed on the surface of the substrate, and the like cannot be exposed to high temperatures.

In order that the two-dimensional confinement type waveguide of FIG. 2B may be produced, the core 14 is formed in a line fashion on the cladding 13. A method for the formation is, for example, a method involving patterning a reaction liquid for the formation of the core onto the cladding 13 to form the core 14 by, for example, a soft lithography method, an ink jet method, or pen lithography. Alternatively, the line-shaped core 14 can be obtained by selectively removing an unnecessary portion out of the core formed on the cladding 13 through an etching step such as photolithography.

Any method can be employed as a method of forming the cladding as long as the method enables the control of the thickness of the cladding and uniform formation of the cladding. For example, a dry process such as sputtering or vapor deposition, or a wet process such as a sol-gel method is applicable. When the cladding 12 must be partially formed upon, for example, production of an X-ray waveguide for oblique incidence of an X-ray illustrated in FIG. 3A, a method of forming the cladding 12 including masking the core 14 with, for example, a metal mask has to be employed. A method involving partially removing the cladding through an etching step can also be employed.

In addition, the core of the X-ray waveguide of the present invention is produced by a method based on a self-assembly process, and a structure in which a large number of low electron density portions are provided in a high electron density portion can be produced at a time on the basis of self-assembly by one step. Therefore, an X-ray waveguide can be provided by a process simpler and quicker than a conventional one.

### Example 1

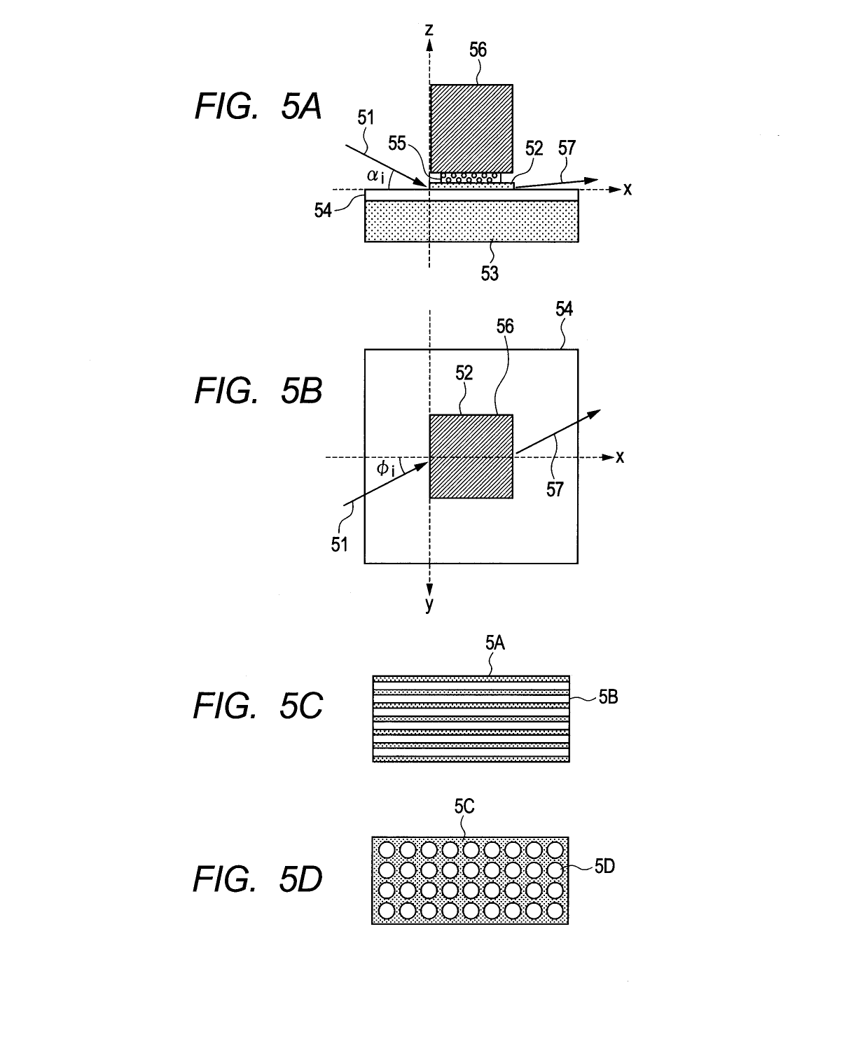

This example is an example in which a one-dimensional confinement-type X-ray waveguide using a laminar structure 54 of a configuration illustrated in each of FIGS. 5A, B, and C whose low electron density portions were each an alkyl was produced and its X-ray propagation behavior was investigated.

First, a silicon wafer 53 (30 mm×30 mm×0.5 mm) was prepared as a substrate, and its surface was cleaned in an ozone apparatus. Next, an alkyl chain-containing siloxane oligomer as a precursor for the laminar structure was synthesized. Decyltrichlorosilane (0.11 mol) was dissolved in diethyl ether (250 mL), and then a mixed solution was dropped while the resultant solution was vigorously stirred in an ice bath. The mixed solution is formed of tetrahydrofuran (350 mL), diethyl ether (365 mL), pure water (6.5 mL), and aniline (33.0 mL). After the mixture had been stirred for 2 hours, the precipitate was removed by filter filtration, and then hexane was added to the filtrate. After that, the solvent was evaporated. Thus, solid matter was obtained. After having been separated by suction filtration, the solid matter was sufficiently washed with cooled acetone and then dried in a vacuum. The solid matter after the drying was dissolved in tetrahydrofuran, and then the solution was subjected to ²⁹Si-NMR measurement. As a result, it was confirmed that the solid matter was an alkyl chain-containing siloxane oligomer having the structure of C₁₀H₂₁Si(OSi(OMe)₃)₃.

The siloxane oligomer, tetramethoxysilane, tetrahydrofuran, pure water, and hydrochloric acid were mixed, and a molar ratio among them in the stated order was adjusted to 1.0:2.0:15:14:0.0050. Further, the solid content was dissolved by stirring. After a lapse of 2.5 hours, tetrahydrofuran was added to the solution, and then the molar ratio was adjusted to 1.0:2.0:60:14:0.0050. Thus, a reaction liquid was prepared.

The top of the silicon wafer 53 was coated with the reaction liquid solution by spin coating (5,000 rpm). The silicon wafer 53 after the spin coating was placed in a thermo-hygrostat at 20° C. and a humidity of 40%, and was then held for 1 day or longer. Thus, the core 54 was formed on the silicon wafer 53. The observation of the core 54 with an electron microscope confirmed that the core was the laminar structure illustrated in FIG. 5C. A high electron density portion 5A and a low electron density portion 5B of the laminar structure are silica and a decyl group, respectively. In addition, observation with an electron microscope confirmed that the thickness of silica of which the high electron density portion 5A of the core 54 was formed was twice or less as large as the oozing length of an evanescent wave at an angle equal to or smaller than the total reflection critical angle of silica.

In order that the peripheral portion of the silicon wafer 53 having the thickness distribution of the core 54 as a result of nonuniform application of the reaction liquid might be eliminated, the central portion of the silicon wafer 53 (20 mm×20 mm) was cut and taken out. Further, the top of the cut piece was masked with a metal mask made of aluminum, and then silica 52 as a cladding was formed only on the central portion of the core 54 (5.0 mm×5.0 mm) by magnetron sputtering so as to have a thickness of 300 nm. Further, a lead glass 56 (bottom face: 4.5 mm×4.5 mm, height: 6 mm) was bonded onto the silica 52 with a silver paste 55 so as to serve as a shielding material for a reflected X-ray and a direct beam that might inhibit the measurement of a transmitted X-ray 57. An X-ray waveguide was produced by the foregoing steps.

The characteristics of the produced X-ray waveguide were investigated with an X-ray microbeam (4 μm×4 μm, 12 keV). The position at which an X-ray was incident was aligned with the boundary of the portion where the silica 52 as the cladding was formed. Then, as illustrated in FIGS. 5 A and 5B, an X-ray microbeam 51 was made incident on the X-ray waveguide. The optical path length by which the X-ray was guided at φᵢ=0° out of the incidence angle of the X-ray was set to 5 mm. In addition, the αᵢ was gradually increased from 0°, and then the intensities of the transmitted X-ray 57 at different αᵢ's were detected with a CCD camera and a photodiode connected to an X-ray image intensifier.

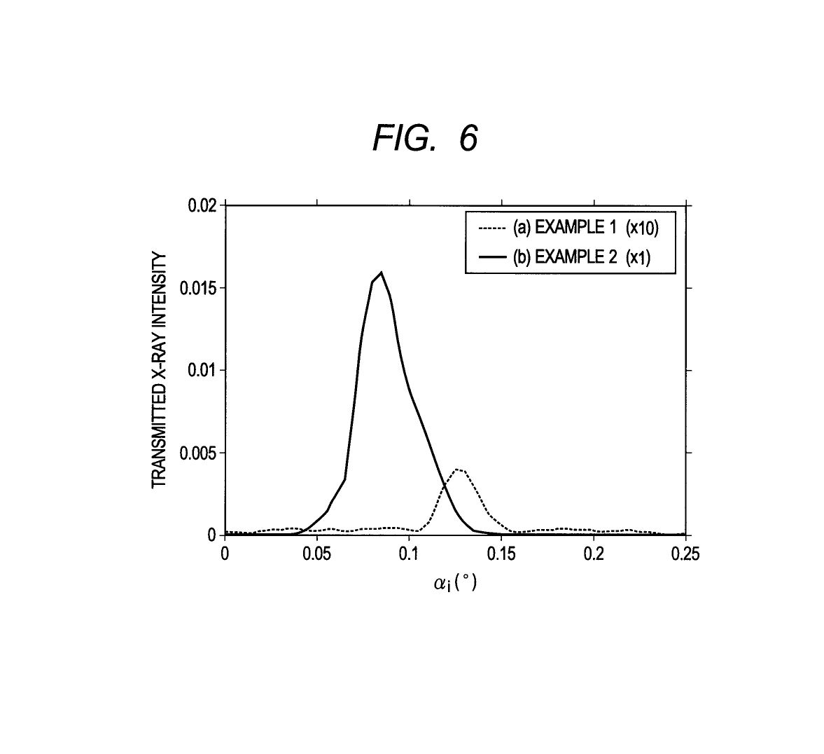

The following facts were confirmed. The transmitted x-ray intensity for the incidence angle αᵢ was as illustrated in FIG. 6, and at a specific αᵢ, the intensity of the transmitted X-ray 57 increased and the guided mode of the X-ray was formed.

### Example 2

This example is an example in which a one-dimensional confinement-type X-ray waveguide using a non-laminar structure 54 of a configuration illustrated in each of FIGS. 5A, 5B, and 5D whose low electron density portions were each a pore was produced and its X-ray propagation behavior was investigated.

First, a silicon wafer 53 (35 mm×35 mm×0.5 mm) was prepared as a substrate, and its surface was cleaned in an ozone apparatus. A polyamic acid solution was applied by spin coating (2,000 rpm), and then the resultant was baked at 200° C. for 1 hour. Thus, a polyimide layer was formed. The presence of the polyimide film enables uniform formation of a core on the silicon wafer 53.

Next, a reaction liquid for the production of the core was prepared. 7.51 grams of C₁₆H₃₅(OCH₂CH₂)₁₀OH (polyethylene oxide 10 hexadecyl ether) were stirred while being heated so as to be melted, and then 159.9 g of pure water and 26.5 mL of concentrated hydrochloric acid (36%) were added to the melt. The resultant solution was stirred for 1 hour or longer while its temperature was held at 80° C. After the solution had been cooled to 27° C., 2.24 mL of tetraethoxysilane was added to the solution, and then the mixture was stirred for 150 seconds. Thus, the reaction liquid was prepared.

The silicon wafer 53 was placed in a Teflon (registered trademark) container with its surface directed downward, and then the reaction liquid was poured into the container so that the substrate might be completely covered with the reaction liquid. Then, the Teflon (registered trademark) container was completely sealed. In this case, a quartz substrate (35 mm×35 mm×1.1 mm) was prepared, and the surface of the silicon wafer 53 was covered with the quartz substrate through a spacer. After that, the container was introduced into an oven at 80° C., and then the contents were subjected to a reaction for 5 days.

After that, the silicon wafer 53 taken out of the container was washed with ultrapure water and then air-dried. In order that the surfactant C₁₆H₃₅(OCH₂CH₂)₁₀OH as an organic substance and the polyimide layer might be removed, the resultant was introduced into an electric furnace under an air atmosphere, and the temperature in the furnace was increased to 400° C. at 2° C. per minute. After having reached 400° C., the temperature was held at the value for 10 hours. After that, the temperature was decreased to room temperature at 2° C. per minute.

The core 54 was formed on the silicon wafer 53 by the foregoing steps. The observation of the core 54 with an electron microscope confirmed that the core was the non-laminar structure illustrated in FIG. 5D. A high electron density portion 5C and a low electron density portion 5D of the non-laminar structure are silica and a pore, respectively. In addition, observation with an electron microscope confirmed that the thickness of silica of which the core was formed was twice or less as large as the oozing length of an evanescent wave at an angle equal to or smaller than the total reflection critical angle of silica.

Further, the silica 52, the silver paste 55, and the lead glass 56 were placed by the same steps as those of Example 1. Thus, an X-ray waveguide was produced. The characteristics of the produced X-ray waveguide were investigated with an X-ray microbeam (4 μm×4 μm, 12 keV). The position at which an X-ray was incident was aligned with the boundary of the portion where the silica 52 as the cladding was formed. Then, as illustrated in FIGS. 5 (A and B), an X-ray microbeam 51 was made incident on the X-ray waveguide. The optical path length by which the X-ray was guided at φᵢ=0° out of the incidence angle of the X-ray was set to 5 mm. In addition, the αᵢ was gradually increased from 0°, and then the intensities of the transmitted X-ray 57 at different αᵢ's were detected with a CCD camera and a photodiode connected to an X-ray image intensifier.

The following facts were confirmed. The transmitted x-ray intensity for the incidence angle αᵢ was as illustrated in FIG. 6, and at a specific αᵢ, the intensity of the transmitted X-ray 57 increased and the guided mode of the X-ray was formed. In addition, the transmitted x-ray intensity was confirmed to be larger than that of Example 1 where the low electron density portions were each an organic substance.

### Comparative Example 1

This comparative example is an example in which a one-dimensional confinement-type X-ray waveguide using an artificial multilayer film whose low electron density portions are each carbon is produced and its X-ray propagation behavior is investigated.

First, a silicon wafer (20 mm×20 mm×0.5 mm) is prepared as a substrate, and its surface is cleaned in an ozone apparatus. Next, a nickel layer (20 nm) serving as a cladding is formed on the silicon wafer by magnetron sputtering. Further, seven layers each of carbon (45.7 nm) and nickel (2.5 nm) are alternately formed by magnetron sputtering to form an artificial multilayer film.

The top of the artificial multilayer film was masked with a metal mask made of aluminum, and then nickel as a cladding was formed only on the central portion of the artificial multilayer film (5.0 mm×5.0 mm) by magnetron sputtering so as to have a thickness of 20 nm. Further, a lead glass (bottom face: 4.5 mm×4.5 mm, height: 6 mm) is bonded onto the nickel with a silver paste so as to serve as a shielding material for a reflected X-ray and a direct beam that might inhibit the measurement of a transmitted X-ray 57. An X-ray waveguide is produced by the foregoing steps.

The characteristics of the produced X-ray waveguide are investigated with an X-ray microbeam (4 μm×4 μm, 12 keV). The position at which an X-ray is incident is aligned with the boundary of the portion where the nickel as the cladding is formed. Then, an X-ray microbeam is made incident on the X-ray waveguide. The optical path length by which the X-ray is guided at φᵢ=0° out of the incidence angle of the X-ray is set to 5 mm. In addition, the αᵢ is gradually increased from 0°, and then the intensities of the transmitted X-ray at different αᵢ's are detected with a CCD camera and a photodiode connected to an X-ray image intensifier.

It is confirmed that the transmitted x-ray intensity for the incidence angle αᵢ shows the maximum intensity (peak intensity) at αᵢ=0.16° and a guided mode is formed at the angle. However, the intensity is about 50% of the peak intensity of Example 1.

The X-ray waveguide of the present invention is useful in, for example, the field of an analysis technology involving using an X-ray because the waveguide can provide an X-ray beam having a small beam size and a strong intensity.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-127336, filed Jun. 2, 2010, which is hereby incorporated by reference herein in its entirety.

1. An X-ray waveguide, comprising:
a core for guiding an X-ray; and
a cladding for confining the X-ray in the core, wherein:
the core has a low electron density portion and a high electron density portion having a higher electron density than an electron density of the low electron density portion;
the low electron density portion is provided in the high electron density portion; and
the low electron density portion is formed of one of a pore and an organic substance.

2. The X-ray waveguide according to claim 1, wherein:
the core includes a laminating structure obtained by laminating unit structures in each of which the low electron density portion is provided in the high electron density portion in a certain direction; and
a laminating direction of the unit structures is perpendicular to a propagating direction of the X-ray.

3. The X-ray waveguide according to claim 2, wherein:
the certain direction is parallel to an interface between the core and the cladding; and
the laminating direction of the unit structures is perpendicular to the interface between the core and the cladding.

4. The X-ray waveguide according to claim 2, wherein the high electron density portion has a thickness not more than twice as large as an oozing length of an evanescent wave L represented by the following formula (1) by which an evanescent wave of the X-ray oozes toward the high electron density portion
$$L = \frac{λ}{2 π \sqrt{{n}_{1}^{2} {cos}^{2} α - {n}_{2}^{2}}} \qquad formula ( 1 )$$
in the formula (1):
L represents an oozing length of an evanescent wave;
λ represents a wavelength of the X-ray;
n₁ represents a refractive index of the low electron density portion;
n₂ represents a refractive index of the high electron density portion; and
α represents an incidence angle of the X-ray from the low electron density portion to the high electron density portion.

5. The X-ray waveguide according to claim 1, wherein the core has a structure in which the low electron density portion, which is formed of the organic substance and is laminar, is provided in the high electron density portion, which is formed of an inorganic oxide, in a certain direction.

6. The X-ray waveguide according to claim 1, wherein the core has a structure in which the low electron density portion, which is formed of one of the pore and the organic substance and is of one of a tubular shape and a spherical shape, is provided in the high electron density portion, which is formed of an inorganic oxide, in a certain direction.

7. A method of producing the X-ray waveguide of claim 1, comprising:
preparing a substrate serving as a part of the cladding;
forming the core on a surface of the substrate; and
forming another part of the cladding one of on a part of the core and on a periphery of the core.

8. The method of producing the X-ray waveguide according to claim 7, wherein the forming the core is performed by a self-assembly process involving using a reaction liquid containing an organic substance.
